(19) United States
(12) Patent Application Publication
(10) Pub. No.: US 2011/0224356 A1
(43) Pub. Date: Sep. 15, 2011

(54) LOW SURFACE ENERGY BLOCK CO-POLYMER PREPARATION METHODS AND APPLICATIONS

(75) Inventors: Scott C. Schmidt, Woodbury, MN (US); Peter A. Callais, Conroe, TX (US); Noah E. Macy, Royersford, PA (US); Jean-Marc Corpart, King of Prussia, PA (US); Jason S. Ness, Woodbury, MN (US); Jeffrey J. Cernohous, Hudson, WI (US)

(73) Assignee: Arkema Inc., Philadelphia, PA (US)

(21) Appl. No.: 13/114,297

(22) Filed: May 24, 2011

Related U.S. Application Data
(63) Continuation of application No. 12/097,149, filed on Jun. 12, 2008.
(60) Provisional application No. 60/750,870, filed on Dec. 16, 2005.

(51) Int. Cl. C09D 153/00

(52) U.S. Cl. 524/505

(57) ABSTRACT

Methods for the preparation of low surface energy block co-polymers are disclosed. The block co-polymers comprise at least two blocks, each of which comprises, in polymerized form, an acrylic monomer, a methacrylic monomer, or a mixture thereof. At least one block is a low surface energy block, which comprises, in polymerized form, a low surface energy monomer. Low surface energy macroinitiators useful in forming the block co-polymers are also disclosed. The block co-polymers may be prepared by nitroxide mediated controlled free radical polymerization.

### CROSS-REFERENCE TO RELATED APPLICATIONS

This application is a continuation application of U.S. application Ser. No. 12/097,149 filed Jun. 12, 2008 which claimed priority on U.S. Provisional Patent Application No. 60/750,870, filed Dec. 16, 2005, incorporated herein by reference.

### FIELD OF THE INVENTION

This invention relates to block co-polymers. In particular, this invention relates to co-polymers that comprise low surface energy blocks and to processes for their preparation.

### BACKGROUND OF THE INVENTION

It is often desirable to modify the surface properties of bulk polymers to impart specific properties to the surface (e.g., permeability, wettability, paintability, solvent resistance, adhesive affinity, hydrophilicy, hydrophobicity, biocompatibility, dirt and stain resistance, etc.) that are not inherent in the bulk polymer. These properties often demand different characteristics than those responsible for the mechanical performance of the bulk polymer, making it difficult simultaneously to achieve the desired surface and bulk properties using a single polymer.

A common route of surface modification is by functionalization of a preformed material. However, this typically requires specialized equipment, adds at least one additional step to the process of polymer preparation, may be only partially successful due to incomplete functionalization, and may require extensive processing after surface modification to remove reaction products and unreacted starting materials.

Surface modification via self-organization is an efficient method for avoiding these problems. In this process, co-polymers containing low surface energy blocks self-segregate into ordered microstructures with the low surface energy blocks residing at the surface. This process is attractive because the properties of the bulk polymer are not substantially changed by the addition of a small amount of a co-polymer containing low surface energy units.

Co-polymers that contain low surface energy monomers have been prepared by conventional free radical techniques. However, it is difficult to control the polymer composition and molecular weight distribution of the co-polymers. Thus, co-polymers prepared by this method tend to have a broad molecular weight distribution and tend to contain significant amounts of high and very low molecular weight co-polymer, which can give undesirable properties to the resulting compositions. In addition, because the low surface energy monomer units are randomly distributed along the co-polymer chain, it is difficult for them organize at the surface of the bulk polymer. Furthermore, to achieve good surface coverage high levels of low surface energy monomer units are required.

Although co-polymers that contain low surface energy blocks have been prepared by various methods, such as living anionic polymerization, atom transfer polymerization, and group transfer polymerization, each of the methods has disadvantages. Some methods can be used with only a limited number of monomers and are not generally applicable to wide variety of monomers. Some methods are tedious and difficult to carry out, especially on a large scale, because they require strict control of the polymerization conditions and/or require extremely pure reagents for efficient polymerization. Some give poor control over the molecular weight distribution and/or composition of the products, and some contribute undesirable byproducts that must be removed by post polymer processing. Thus, a need exists for a method for preparing co-polymers containing low surface energy blocks that does not have these disadvantages.

### SUMMARY OF THE INVENTION

In one aspect, the invention is a controlled method for the preparation of block co-polymers comprising at least two blocks, in which the co-polymer comprises at least one low surface energy block and in which at least two blocks comprise, in polymerized form, an acrylic monomer, a methacrylic monomer, or a mixture thereof. In one aspect, the invention is a method of preparing a block co-polymer comprising a first block attached to a second block, the method comprises the steps of:

a) preparing the first block by polymerizing a first monomer in the presence of a nitroxide;

b) preparing the second block by polymerizing a second monomer in the presence of the nitroxide;

in which:

the first monomer and the second monomer each comprise an acrylic monomer, a methacrylic monomer, or a mixture thereof; and

either the first monomer or the second monomer comprises a low surface energy monomer, or both the first monomer and the second monomer each comprise a low surface energy monomer.

The method can be carried out in a single reaction vessel, i.e., is a “one-pot” synthesis of block co-polymers in which at least one block is a low surface energy block.

In further aspect the invention is a block co-polymer prepared by the method of the invention. In another aspect the invention is a block co-polymer comprising at least two blocks, in which the co-polymer comprises at least one low surface energy block and in which at least two blocks comprise, in polymerized form, an acrylic monomer, a methacrylic monomer, or a mixture thereof. In yet another aspect, the invention is a controlled method for the preparation of a low surface energy polymer, useful as a macroinitiator of free radical polymerization in the presence of a nitroxide, in which the polymer contains a nitroxide end group. In yet another aspect, the invention is a method for preparing a polymer in which the initiator is a low surface energy alkoxyamine. In yet another aspect of the invention, the invention is a polymer prepared using a low surface energy initiator.

In yet another aspect, the invention is a polymer mixture comprising the block co-polymer. In yet another aspect, the block co-polymers are mixed with non-low surface energy polymers, for example, polymers that do not comprises low surface energy blocks. The block co-polymer migrates or “blooms” to the surface of the resulting polymer mixture and can modify the surface properties of the resulting polymer mixture. In another aspect, the invention is the use of the block co-polymers polymers as surface modifying agents.

### DETAILED DESCRIPTION OF THE INVENTION

Unless the context indicates otherwise, in the specification and claims the terms low surface energy monomer, fluorine-containing monomer, silicon-containing monomer, non-low surface energy monomer, first monomer, second monomer, acrylic monomer, methacrylic monomer, free radical polymerizable monomer, initiator, bulk polymer, macroinitiator, nitroxide, alkoxyamine, and similar terms also include mixtures of such materials. A low surface energy block comprises units derived from the free radical polymerization of a low surface energy monomer, typically units derived from the free radical polymerization of a fluorine-containing monomer and/or a silicon-containing monomers. A non-low surface energy polymer is essentially free of units derived from low surface energy monomers and may be completely free of units derived from the polymerization of low surface energy monomers. Unless otherwise specified, all percentages are percentages by weight and all temperatures are in degrees Centigrade (degrees Celsius).

In one aspect, the invention is a method for the controlled preparation of block co-polymers comprising at least two blocks, in which the co-polymer comprises at least one low surface energy block and in which at least two blocks comprise, in polymerized form, an acrylic monomer, a methacrylic monomer, or a mixture thereof. Low surface energy blocks comprise units derived from the free radical polymerization of low surface energy monomers, typically units derived from the free radical polymerization of fluorine-containing monomers and/or silicon-containing monomers. Non-low surface energy blocks are essentially free of low surface energy monomers.

The block co-polymer comprises at least a first block and a second block. The first block is prepared by polymerizing a first monomer in the presence of a nitroxide. The second block is prepared by polymerizing a second monomer in the presence of the nitroxide. Either the first monomer and/or the second monomer may be a mixture of two or more monomers. When the first monomer and/or the second monomer is a mixture of monomers, the monomers in the mixture may be randomly co-polymerized, or they can be co-polymerized in gradient fashion. Either the first block or the second block may be a low surface energy block, or both the first block and the second block may be low surface energy blocks.

The low surface energy block comprises, in polymerized form, one or more low surface energy monomers, typically a fluorinated monomer or mixture of fluorinated monomers and/or a silyl containing monomer or a mixture of silyl containing monomers. The low surface energy block may comprise, in polymerized form, only low surface energy monomers or it may also comprise non-low surface energy monomers. The first monomer and/or the second monomer may also comprise one or more free radical polymerizable non-acrylic and non-methacrylic monomers, for example vinyl monomers such as vinyl acetate, vinyl methyl ketone, and vinyl methyl ether; styrene and substituted styrenes such as a-methyl styrene, 2-, 3-, and 4-methyl styrene, 2-, 3-, and 4-chloro styrene, and styrene sulfonic acid and its salts such as sodium styrene sulfonate; acrylonitrile; and methacrylonitrile.

Co-polymers containing low surface energy blocks may be prepared by nitroxide mediated controlled free radical polymerization. If desired, the preparation can be carried out in a single reaction vessel, i.e., the method is a “one-pot” synthesis of the block co-polymers. Nitroxide mediated controlled free radical polymerization technology involves the use of nitroxide-based mediators to control free radical polymerization with reversible termination, so that sequenced co-polymers, including block co-polymers, with defined structure can be prepared. The preparation of polymers by nitroxide mediated controlled free radical polymerization and the preparation of appropriate nitroxides is disclosed, for example, in E. Rizzardo, Chem. Aust., 1987, 54 (January-February), 32; Solomon, U.S. Pat. No. 4,581,429; Georges, U.S. Pat. No. 5,322,912; Georges, U.S. Pat. No. 5,401,804; Frechet, U.S. Pat. No. 6,663,855; Couturier, U.S. Pat. No. 6,700,007; Gillet, U.S. Pat. No. 6,624,322; Gillet, U.S. Pat. No. 6,538,141; Couturier, U.S. Pat. No. 6,569,967; Couturier, U.S. Pat. No. 6,495,720; Bertin, U.S. Pat. No. 6,346,589; Senninger, U.S. Pat. No. 6,509,328; Callais, U.S. Pat. No. 6,762,263, and Couturier, U.S. Pat. Pub. No. 2005/0065119; the disclosures of all of which are incorporated herein by reference, and especially in Grimaldi, U.S. Pat. No. 6,255,448; Guerret, U.S. Pat. No. 6,646,079; and Guerret, U.S. Pat. No. 6,657,043; the disclosures of which are all incorporated herein by reference.

During formation of the co-polymer, the co-polymer is a “living polymer.” Because the nitroxide is retained as the end group, it can separate to form a free radical. The chain can add one or more monomer units until it is again reversibly terminated by the nitroxide. The mechanism of control may be represented by the following:

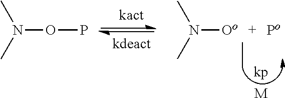

in which M is a polymerizable monomer, P represents the growing polymer chain, and K_{deact}, k_{act} and kₚ are, respectively, the rate constants for deactivation, activation, and propagation.

The key to the control is associated with the rate constants K_{deact}, k_{act} and kₚ (see T. Fukuda and A. Goto, Macromolecules, 1999, 32, 618-623). If the ratio K_{deact}/k_{act} is too high, the polymerization is blocked, whereas when the ratio kₚ/k_{deact} is too high or when the ratio k_{deac}/k_{act} is too low though, the polymerization is uncontrolled. It has been found (P. Tordo et al., Polym. Prep., 1997, 38, 729-730; and C. J. Hawker et al., Polym. Mater. Sci. Eng., 1999, 80, 90-91) that β-substituted alkoxyamines efficiently initiate and control the polymerization of several types of monomers, whereas TEMPO [2′,2′,6′,6′-tetramethyl-1′-piperidyloxy-] based initiators, such as (2′,2′,6′,6′-tetramethyl-1′-piperidyloxy-)methylbenzene, only control the polymerizations of styrene and styrene derivatives.

Because the polymerization process is controlled and the polymer is a living polymer, the process makes it possible to prepare block co-polymers in which the composition and chain length of each block are closely controlled by successive introduction of different monomers or mixtures of monomers into the polymerization medium. In addition, the living nature of the polymerization makes it possible to prepare multimodal co-polymers. Polymers that are better defined and more varied than those obtained by other processes can be prepared in a conventional reactor. Further, due to the robust nature of this process, functionalized monomers, such as monomers comprising hydroxyl, carboxyl acid, glycidyl, and/or amino groups, can be incorporated directly in the co-polymer. The functional groups do not require post-polymerization modification, but may be modified after polymerization if desired

In one process, the free radical polymerization or co-polymerization is carried-out under the usual conditions for the monomer or monomers under consideration with the difference being that a β-substituted stable free radical is added to the mixture. Depending on the monomer or monomers, it may also be necessary to introduce a traditional free radical initiator into the polymerization mixture.

Alkoxyamines, which combine the controller and initiator in one molecule, can be used as initiators to prepare the polymers and co-polymers. The alkoxyamine thermally separates into two free radicals, one of which is a carbon centered radical that acts as the initiator of the free radical polymerization so it is not necessary to use a separate free radical initiator. The other free radical is a nitroxide, a stable free radical, which controls the polymerization by reversibly terminating the polymerization. The alkoxyamines may be used for the polymerization and co-polymerization of any monomer containing a carbon-carbon double bond, which is capable of undergoing free-radical polymerization. Free radical-polymerizable monomers that contain functional monomers such as epoxy and hydroxy as well as acid containing monomers are also easily polymerized by this method.

Useful stable nitroxide free radicals have the general structure:

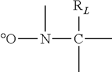

in which the monovalent R_{L} radical has a molar mass greater than 15. The monovalent R_{L} group is in the β-position with respect to the nitrogen atom of the nitroxide. The remaining valencies of the carbon atom and of the nitrogen atom of the nitroxide can be bonded to various groups, such as a hydrogen or a hydrocarbon group, for example a substituted or unsubstituted alkyl, aryl or aralkyl group comprising from 1 to 10 carbon atoms. The β-position may, for example, also be attached to a hydrogen. The carbon atom and the nitrogen atom can be connected via a bivalent group to form a ring. However, the remaining valencies of the carbon atom and of the nitrogen atom are preferably each bonded to monovalent groups. R_{L} preferably has a molar mass greater than 30. R_{L} can, for example, have a molar mass of between 40 and 450. R_{L} can, for example, comprise a phosphoryl group, such as:

—P(O)R_{g}Rₕ

in which R_{g} and Rₕ, which can be identical or different, are selected from alkyl, cycloalkyl, alkoxy, aryloxy, aryl, aralkyloxy, perfluoroalkyl and aralkyl groups and can comprise from one to 20 carbon atoms. R_{g} and/or Rₕ can also be a halogen atom, such as a chlorine or bromine or fluorine or iodine atom. R_{L} can also comprise at least one aromatic ring, such as the phenyl radical or the naphthyl radical, which can be substituted, for example, with an alkyl group of one to four carbon atoms.

The stable free radical can be, for example: tert-butyl 1-phenyl-2-methylpropyl nitroxide, tert-butyl 1-(2-naphthyl)-2-methylpropyl nitroxide, tert-butyl 1-diethylphosphono-2,2-dimethylpropyl nitroxide, tert-butyl 1-dibenzylphosphono-2,2-dimethylpropyl nitroxide, phenyl 1-diethylphosphono-2,2-dimethylpropyl nitroxide, phenyl 1-diethylphosphono-1-methylethyl nitroxide, 1-phenyl-2-methylpropyl 1-diethylphosphono-1-methylethyl nitroxide. Specifically, one useful stable free radical is N-t-butyl-N-[1-diethylphosphono-(2,2,-dimethylpropyl)]-nitroxide (DEPN), which has the following structure:

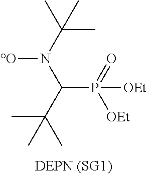

The DEPN group may be linked to an isobutyric acid radical or an ester or amide thereof. A useful initiator is iBA-DEPN initiator, which has the following structure, in which SG1 is the DEPN group.

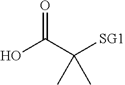

iBA-DEPN initiator is stable below about 25° C., but when heated above 25° C., it separates into two free radicals, one of which initiates polymerization and one of which, the SG1 nitroxide, reversibly terminates polymerization. The SG1 nitroxide dissociates from methacrylates above about 25° C. and disassociates from acrylates above about 90° C.

Other useful initiators include esters and amides of SG1C(CH₃)₂CO₂H. If esters or amides are used, they are preferably derived from lower alkyl alcohols or amines, respectively, for example, the methyl ester, SG1C(CH₃)₂CO₂CH₃. Polyfunctional esters, for example the diester of 1,6-hexanediol [SG1C(CH₃)₂CO₂]₂(CH₂)₆], can also be used.

Typically, a monofunctional alkoxyamine is used to prepare an AB block co-polymer. Difunctional initiators can be used to prepare symmetrical A-B-A block co-polymers. However, a triblock co-polymer can also be made from a monofunctional alkoxyamine by first reacting the monofunctional alkoxyamine with a diacrylate (such as butanediol diacrylate) to create a difunctional alkoxyamine. Initiators with higher functionality, for example the tetraacrylate or tetramethacrylate ester of pentaerythritol [C(CH₂OCOC(R)═CH₂)₄], in which R is hydrogen or methyl, can be used to prepare star co-polymers. None of the reactions require the addition of further initiation source (such as an organic peroxide), though in some cases, peroxides or other conventional free radical initiators might be used at the end of the reaction to “chase” the residual monomer.

The co-polymerization may be carried out under conditions well known to those skilled in the art, taking into account the monomers under consideration, the alkoxyamine initiator, and the desired product, including for example, its desired molecular weight. Typically it is not necessary to use a mixture of alkoxyamines or a mixture of nitroxides. Thus, the polymerization or co-polymerization may be performed, for example, in bulk, in solution, in emulsion or in suspension, at temperatures ranging from about 0° C. to about 250° C. and preferably ranging from about 25° C. to about 150° C. The initiator typically comprises about 0.005% to about 5% by weight of the reaction mixture.

“Sequenced” block co-polymers may be produced by 1) polymerizing a monomer or a mixture of monomers in the presence of an alkoxyamine at a temperature ranging from about 25° C. to about 250° C. and preferably ranging from about 25° C. to about 150° C.; 2) allowing the temperature to fall and, optionally, evaporating off the residual monomer(s); 3) introducing a new monomer mixture of monomers into the reaction mixture; and 4) raising the temperature to polymerize the new monomer or mixture of monomers. This process may be repeated to form additional blocks. Polymers made by this process will have nitroxide end groups. They can remain on the end of the polymer chains or be removed by an additional processing step.

In one aspect of the invention, a low surface energy alkoxyamine can be used to form a polymer. The polymer may be a homopolymer, a random co-polymer, a gradient co-polymer, or a block co-polymer. Alkoxyamines useful as initiators in this aspect of the invention, include, for example, alkoxyamines that comprise a fluoroalkyl group, such as esters formed by esterification of SG1C(CH₃)₂CO₂H with partially fluorinated alkyl alcohols. Preferably, these esters are formed from long chain (i.e., ≧C8) partially fluorinated alcohols and mixtures thereof, for example the 1H,1H-perfluorododecyl ester SG1C(CH₃)₂CO₂CH₂(CF₂)₁₀CF₃ or the 1H,1H,2H,2H-perfluorododecyl ester SG1C(CH₃)₂CO₂(CH₂)₂(CF₂)₉CF₃. Partially fluorinated alcohols (fluoroalkyl ethanols) of the general structure R_{f}CH₂CH₂OH, in which R_{f} is a floroalkyl group of the general structure —(CF₂)ₙF and n is typically an integer between 2 and 10, are available from the DuPont Company (Wilmington, Del. USA) as ZONYL® BA fluoroalkyl alcohol. Such alkoxyamines can be used as initiators to prepare materials that are end-functionalized or “tipped” with low surface energy functionality. The initiator portion of the alkoxyamine, which contains the low surface energy group, remains on the end of the polymer chain following polymerization.

If a polymer or co-polymer that has a nitroxide end group is mixed with a non-low surface energy polymer, for example with a polyolefin such as polypropylene, and heated by, for example, melt processing, the nitroxide end group is lost, and the polymer or co-polymer grafts to the non-low surface energy polymer. The polymer with the nitroxide end group may be, for example, a polymer or block co-polymer that contains low surface energy monomers, and which either may or may not be end-functionalized with low surface energy functionality.

The low surface energy monomer may be a single monomer or a mixture of monomers that produce polymers with a low surface energy. Such monomers include, for example, fluorine-containing acrylate and methacrylate monomers, silicon-containing acrylate and methacrylate monomers, and mixtures thereof. Monomers that are not acrylate or methacrylate monomers may used in addition to acrylate and/or methacrylate monomers, provided that the first monomer and the second monomer each comprise at least one acrylate or methacrylate monomer. In one aspect of the invention, the first monomer and/or the second monomer do not contain any monomers that are not either an acrylate or a methacrylate.

Fluorine-containing acrylate and methacrylate monomers include, for example, 2-fluoroethyl acrylate and 2-fluoroethyl methacrylate; 1,1,1,3,3,3-hexafluoro-iso-propyl acrylate and 1,1,1,3,3,3-hexafluoro-iso-propyl methacrylate; 1,1-dihydroperfluoroalkyl acrylates and methacrylates of the general structure, CF₃(CF₂),CH₂OCOC(R)═CH₂, in which R is hydrogen or methyl and n is typically 0 to 12, such as, 2,2,2-trifluoroethyl acrylate and 2,2,2-trifluoroethyl methacrylate, 2,2,3,3,3-pentafluoropropyl acrylate and 2,2,3,3,3-pentafluoropropyl methacrylate, 1H,1H-heptafluorobutyl acrylate and 1H,1H-heptafluorobutyl methacrylate, 1H,1H-perfluoropentyl acrylate and 1H,1H-perfluoropentyl methacrylate, 1H,1H-perfluorohexyl acrylate and 1H,1H-perfluorohexyl methacrylate, 1H,1H-perfluorooctyl acrylate and 1H,1H-perfluorooctyl methacrylate, 1H,1H-perfluorodecyl acrylate and 1H,1H-perfluorodecyl methacrylate, 1H,1H-perfluorododecyl acrylate and 1H,1H-perfluorododecyl methacrylate; 1,1,2,2-tetrahydroperfluoroalkyl acrylates and methacrylates of the general structure CF₃(CF₂)_{n′}(CH₂)₂OCOC(R)═CH₂, in which R is hydrogen or methyl and n′ is typically 0 to 11, such as 3,3,4,4,4-pentafluorobutyl acrylate and 3,3,4,4,4-pentafluorbutyl methacrylate, 1H,1H,2H,2H-perfluorohexyl acrylate, 1H,1H,2H,2H-perfluorohexyl methacrylate, 1H,1H,2H,2H-perfluorooctyl acrylate, 1H,1H,2H,2H-perfluorooctyl methacrylate, 1H,1H,2H,2H-perfluorodecyl acrylate and 1H,1H,2H,2H-perfluorodecyl methacrylate, and 1H4H,2H,2H-perfluorododecyl acrylate and 1H,1H,2H,2H-perfluorododecyl methacrylate; 1,1,Ω-trihydroperfluoroalkyl acrylates and methacrylates of the general structure CHF₂(CF₂)_{n″}(CH₂)₂OCOC(R)═CH₂, in which R is hydrogen or methyl and n″ is typically 0 to 12, such as 2,2,3,3-tetrafluoropropyl acrylate and 2,2,3,3-tetrafluoropropyl methacrylate, 1H,1H,5H-perfluoropentyl acrylate and 1H,1H,5H-perfluoropentyl methacrylate, 1H4H,7H-perfluoroheptyl acrylate and 1H,1H,7H-perfluoroheptyl methacrylate, 1H,1H,9H-perfluorononyl acrylate and 1H,1H,9H-perfluorononyl methacrylate, 1H,1H,11H-perfluoroundecyl acrylate and 1H,1H,11H-perfluoroundecyl methacrylate; 2,2,3,4,4,4-hexafluorobutyl acrylate and 2,2,3,4,4,4-hexafluorobutyl methacrylate, perfluorocyclohexyl methyl acrylate and perfluorocyclohexyl methyl methacrylate, 3-(trifluoromethyl)benzyl acrylate and 3-(trifluoromethyl)benzyl methacrylate, pentafluorophenyl acrylate and pentafluorphenyl methacrylate; pentafluorobenzyl acrylate and pentafluorbenzyl methacrylate; pentafluorobenzyl acrylate and pentafluorbenzyl methacrylate; and mixtures thereof. Fluorine-containing monomers that are not acrylate or methacrylate monomers include, for example, fluorine-containing styrenes, such as 2-fluorostyrene, 3-fluorostryrene, 4-fluorostyrene, 2-trifluoromethyl styrene, 3-trifluoromethylstyrene, 4-trifluoromethylstyrene, and pentafluorostyrene; and mixtures thereof.

Silicon-containing acrylate and methacrylate monomers include, for example, (phenyldimethylsilyl)methyl methacrylate (methacryloxymethyl phenyldimethylsilane); trialklysilyl acrylates and methacrylates of the general structure (R′)₃Si(CH₂)ₘOCOC(R)═CH₂, in which R is hydrogen or methyl and R′ is an alkyl group of 1 to 5 carbon atoms, and m is 0 to 6, such as trimethylsilyl acrylate (acryloxytrimethylsilane) and trimethylsilyl methacrylate (methacryloxytrimethylsilane), triethylsilyl acrylate and triethylsilyl methacrylate, tri(iso-propyl)silyl acrylate and tri(iso-propyl)silyl methacrylate, tri-n-butyl silyl acrylate and tri-n-butyl silyl methacrylate, trimethylsilylmethyl acrylate (acryloxymethyltrimethylsilane) and trimethylsilylmethyl methacrylate (methacryloxymethyltrimethylsilane), tri(iso-propyl)silylmethyl acrylate and tri(iso-propyl)silylmethyl methacrylate, tri-n-butyl silylmethyl acrylate and tri-n-butyl silylmethyl methacrylate, 2-(trimethylsilyl)ethyl acrylate and 2-(trimethylsilyl)ethyl methacrylate, 3-(trimethylsilyl)propyl acrylate and 3-(trimethylsilyl)propyl methacrylate; trialkoxysilyl acrylates and methacrylates of the general structure (R′O)₃Si(CH₂)_{m′}OCOC(R)═CH₂, in which R is hydrogen or methyl and R″ is an alkyl group of 1 to 5 carbon atoms, and m′ is 0 to 6, such as 2-(trimethoxysilyl)ethyl acrylate and 2-(trimethoxysilyl)ethyl methacrylate, 3-(trimethoxysilyl)propyl acrylate and 3-(trimethoxysilyl)propyl methacrylate, 3-(triethoxysilyl)propyl acrylate and 3-(trimethoxysilyl)propyl methacrylate, 3-(tri-n-propoxysilyl)propyl acrylate and 3-(tri-n-propoxysilyl)propyl methacrylate, 3-(tri-iso-propoxysilyl)propyl acrylate and 3-(tri-isopropoxysilyl)propyl methacrylate, 3-(tri-n-butoxysilyl)propyl acrylate and 3-(tri-n-butoxysilyl)propyl methacrylate, 4-(trimethoxysilyl)butyl acrylate and 4-(trimethoxysilyl)butyl methacrylate, 5-(trimethoxysilyl)pentyl acrylate and 5-(trimethoxysilyl)pentyl methacrylate, 6-(trimethoxysilyl)hexyl acrylate and 6-(trimethoxysilyl)hexyl methacrylate; and mixtures there of. Silicon-containing non-acrylate or methacrylate monomers include, for example, vinyl compounds such as vinylphenyldimethylsilane, phenylvinyldimethoxysilane, vinyl(trifluoromethyl)dimethylsilane, vinyl tris-t-butoxysilane, dimethylvinylmethoxysilane, vinylmethyldimethoxysilane, vinyl-t-butyldimethylsilane, vinyltrimethoxysilane, and vinyl terminated poly(dimethylsiloxane); and mixtures thereof.

To form a low surface energy block, a monomer that forms a polymer with low surface energy (low-surface energy monomer) can be used by itself, or it can be mixed with one or more other monomers that form a polymer with a low surface energy and/or mixed with one or more monomers that do not form polymers with a non-low surface energy (non-low surface energy monomers), such as any monomer or mixture of monomers that can be polymerized by nitroxide mediated controlled free radical polymerization and do not form homopolymers that have a low surface energy. The low surface energy block comprises, in polymerized from, at least one low surface energy monomer (i.e., at least one unit derived from a low surface energy monomer). Preferably, the low surface energy block comprises, in polymerized form, about 5 wt % to about 100 wt % of low surface energy monomer, more preferably about 10 wt % to about 100 wt % of low surface energy monomer, even more preferably about 25 wt % to about 100 wt % of low surface energy monomer, even more preferably about 50 wt % to about 100 wt % of low surface energy monomer. A low surface energy block may also comprise about 90 wt % to about 100 wt % of low surface energy monomer or about 100 wt % of low surface energy monomer.

Numerous non-low surface energy monomers are known to those skilled in the art. Acrylate and methacrylate monomers include acrylic acid, methacrylic acid, salts, esters, anhydrides and amides thereof, and mixtures thereof. The salts can be derived from any of the common metal, ammonium, or substituted ammonium counter ions, such as sodium, potassium, ammonium, and tetramethyl ammonium. The esters can be derived from C₁₋₄₀ straight chain, C₃₋₄₀ branched chain, or C₃₋₄₀ carbocyclic alcohols; from polyhydric alcohols having from about 2 to about 8 carbon atoms and from about 2 to about 8 hydroxyl groups, such as ethylene glycol, propylene glycol, butylene glycol, hexylene glycol, glycerin, and 1,2,6-hexanetriol; from amino alcohols, such as aminoethanol, dimethylaminoethanol and diethylaminoethanol and their quaternized derivatives); or from alcohol ethers, such as methoxyethanol and ethoxyethanol. Typical esters include, for example, methyl acrylate and methyl methacrylate, ethyl acrylate and ethyl methacrylate, n-propyl acrylate and n-propyl methacrylate, n-butyl acrylate and n-butyl methacrylate, iso-butyl acrylate and iso-butyl methacrylate, t-butyl acrylate and t-butyl methacrylate, 2-ethylhexyl acrylate and 2-ethylhexylmethacrylate, octyl acrylate, and octyl methacrylate, decyl acrylate and decyl methacrylate. Typical hydroxyl or alkoxy containing monomers include, for example, 2-hydroxyethyl acrylate and 2-hydroxyethyl methacrylate, hydroxypropyl acrylate and hydroxypropyl methacrylate, glyceryl monoacrylate and glycerol monomethacrylate, 3-hydroxypropyl acrylate and 3-hydroxypropyl methacrylate, 2,3-dihydroxypropyl acrylate and 2,3-dihydroxypropyl methacrylate, 2-methoxyethyl acrylate and 2-methoxyethyl methacrylate, 2-ethoxyethyl acrylate and 2-ethoxyethyl methacrylate, and mixtures thereof. The amides can be unsubstituted, N-alkyl or N-alkylamino mono-substituted, or N,N-dialkyl, or N,N-dialkylamino disubstituted, in which the alkyl or alkylamino groups can be C₁₋₄₀ (preferably C₁₋₁₀) straight chain, C₃₋₄₀ branched chain, or C₃₋₄₀ carbocyclic groups. In addition, the alkylamino groups can be quaternized. Typical amides include, for example, acrylamide and methacrylamide, N-methyl acrylamide and N-methyl methacrylamide, N,N-dimethyl acrylamide and N,N-dimethyl methacrylamide, N,N-di-n-butyl acrylamide and N,N-di-n-butyl methacrylamide, N-t-butyl acrylamide and N-t-butyl methacrylamide, N-phenyl acrylamide, and N-phenyl methacrylamide, N,N-dimethylaminoethyl acrylamide and N,N-dimethylaminoethyl methacrylamide. Typical styrenes include, for example, styrene, α-methyl styrene, styrene sulfonic acid and its salts, and various ring-substituted styrenes, such as 2-, 3-, and 4-methyl styrene, 2-, 3-, and 4-chloro styrene, and 4-vinyl benzoic acid. Typical vinyl compounds include, for example, vinyl acetate, vinyl butyrate, vinyl pyrrolidone, vinyl imidazole, methyl vinyl ether, methyl vinyl ketone, vinyl pyridine, vinyl pyridine-N-oxide, vinyl furan, vinyl caprolactam, vinyl acetamide, and vinyl formamide. Typical polymerizable dienes include, for example, butadiene and isoprene. Typical allyl compounds include, for example, allyl alcohol, allyl citrate, and allyl tartrate. Other monomers include, for example, acrylonitrile, methacrylonitrile, maleic acid, maleic anhydride and its half esters, fumaric acid, itaconic add, and itaconic anhydride and its half esters. The non-low surface energy monomers may be used by themselves or mixed with one or more other non-low surface energy monomers to form the non-low surface energy block.

The nitroxide-mediated polymerization may be used to form block co-polymers, including diblock co-polymers, triblock co-polymers, multiblock co-polymers, star polymers, comb polymers, gradient polymers, and other polymers having a blocky structure. The multiblock and triblock co-polymers may consist of two chemically discrete blocks, such as in A-B-A triblocks or multiblocks of the formula (A-B)ₙ, where n is >1 and A and B represent chemically distinct blocks. Or they may contain 3 or more chemically distinct blocks, such as A-B-C triblocks or A-B-C-D multiblock co-polymers. The star polymers may contain from 3 to 12 arms, more preferably 3 to 8 and these arms may consist of or diblock, triblock, or multiblock co-polymers. Each block may comprise polymerized monomer units derived from a single monomer (a “homoblock”), polymerized monomer units derived from two or more monomers randomly distributed (a “random block”), or polymerized monomer units derived from two or more monomers in which the concentration of one unit increases and the concentration of another unit decreases throughout the block (a “gradient block”).

The block co-polymers have a controlled molecular weight and molecular weight distribution. Preferably the weight average molecular weight (M_{w}) of the co-polymer is from 1,000 to 1,000,000 g/mol, and most preferably from 5,000 to 300,000 g/mol. The molecular weight distribution, as measured by the ratio of the weight average molecular weight to the number average molecular weight (M_{w}/Mₙ), or polydispersity, is generally less than 4.0, preferably equal to or less than 2.5, and more preferably equal to or less than 2.0 or below. Polydispersities of equal to or less than 1.5 or below, and equal to or less than 1.3 or below, may be obtained by the method of the invention.

In yet another aspect, the invention is a controlled method for the preparation of a low surface energy polymer, useful as a macroinitiator of free radical polymerization, in the presence of a nitroxide, in which the polymer contains a nitroxide end group. Polymerization of a low surface energy monomer or mixture of low surface energy monomers produces a low surface energy polymer, terminated by a nitroxide. At least about 50 wt %, preferably about 90 wt %, and more preferably about 100 wt % of the units are derived from low surface energy monomers. This polymer may be used as a macroinitiator of free radical polymerization. Other monomers, for example, non-low surface energy monomers, may be polymerized using this polymer as a macroinitiator. The alkoxyamine initiator may comprise a low surface energy group such as a partially fluorinated alkyl group, but this is not essential. Suitably, the macroinitiator has a molecular weight (M_{w}) of at least 1,000 g/mol, preferably at least 2,000 g/mol, more preferably, at least 4,000 g/mol. The macroinitiator may be isolated, or it can be used in a “one pot” synthesis.

### INDUSTRIAL APPLICABILITY

These co-polymers can be used in additive amounts or used as bulk materials. The block co-polymers containing low surface energy blocks of the invention can be used in a wide variety of applications, such as, compatibilizing agents, foaming agents, surfactants, low surface energy additives (for anti-stain, anti-soil, or anti-stick applications, for wetting or coating applications, and anti-fouling applications), solvent or chemical resistance (in coatings, films, fabricated parts, etc.), preparation of oil and water repellant surfaces (for substrates such as, plastics, textiles, paper, wood, leather, etc.), coatings for medical devices, lubricants, additives and bulk material for electronic applications, thermoplastic elastomers, impact modifiers, adhesives, drug (or pharmaceutical) delivery, cosmetic applications, and many others as will be evident to those skilled in the art.

The block co-polymers containing low surface energy blocks of the invention are useful for modifying the surface energy of polymers, such as those that do not comprise low surface energy monomers or low surface energy blocks. Additive amounts may be included in a wide variety of bulk polymers, especially non-low surface energy polymers, to impart properties that are not inherent to the bulk polymers, such as stain resistance. A non-low surface energy polymer is essentially free of units derived from low surface energy monomers and can be, for example, a condensation polymer or an addition polymer. Non-low surface energy polymers include, for example, acrylate and methacrylate polymers, such as polymethyl methacrylate and co-polymers of methyl methacrylate and/or methyl acrylate with one of more other acrylate and/or methacrylate monomers such as ethyl methacrylate, ethyl acrylate, butyl methacrylate, and butyl acrylate, as well as non-acrylate polymers such as polyesters; polyamides, such as nylons, for example, nylon 6,6, nylon 6, and nylon 12; polyolefins, such as polyethylene and polypropylene; polyurethanes; polystyrene; and vinyl polymers. Applications include food uses, textiles, coatings, pharmaceuticals, paints, and many other industries. Additional applications include fibers, in particular nylon carpet fibers.

The amount of block co-polymer added to modify the surface properties of the bulk polymer (“the additive amount”) will depend to an extent on the amount of monomer units derived from low surface energy monomers in the block co-polymer, the nature of the non-low surface energy polymer (“the bulk polymer”) and on the nature and amount of surface modification desired. Typically, the additive amount of the low surface energy block co-polymer is about 0.1 wt % to about 10 wt % of the polymer mixture, more typically about 0.3 wt % to about 5.0 wt % of the polymer mixture, and still more typically about 0.5 wt % to 2 wt % of the polymer mixture.

The low surface energy block co-polymers can be added to a bulk polymer during melt processing. As it well known to those skilled in the art, addition of the block co-polymer to the bulk polymer may be conveniently carried out by first preparing a concentrate of the co-polymer with a carrier resin, such as the non-low surface energy polymer, and then adding the required amount of the concentrate to the bulk polymer. During melt processing, the low surface energy block co-polymer can “bloom” to the surface of the bulk polymer. This blooming effect preferentially locates the low surface energy block at the air-polymer surface, affording the surface of the bulk polymer the properties inherent in the low surface energy blocks.

Alternatively, the low surface energy block co-polymers can be used in coating compositions. The low surface energy block co-polymer is dissolved or suspended in the solvent of the coating composition along with binder resins and other conventional coating composition ingredients, which are well known to those skilled in the art. Typically the binder resins are acrylic resins, which are well known to those skilled in the art. Typically the other conventional coating composition ingredients comprises one or more pigments, such as titanium dioxide, zinc oxide, iron oxide, phthalocyanine pigments, quinacridone pigments, and/or carbon black. Examples of other conventional ingredients include wetting agents, neutralizing agents, levelling agents, antifoaming agents, light stabilizers, antioxidants, and biocides. After the coating composition has been applied to a substrate, the solvent evaporates to leave the coating on the surface of the substrate. The coating comprises a mixture that comprises the low surface energy block co-polymer, the binder resins, and non-volatile other ingredients Depending the low surface energy block co-polymer and the other ingredients present in the coating composition, heating or curing the coating may or may not be necessary. The low surface energy block co-polymer migrates to the surface of the coating and provides the coating with a low energy surface. This typically makes the coating more resistant to dirt and stains.

Low surface energy macroinitiators, such as are described in Example 1, can be used as initiators to carry out further reactions in many processes and applications as described above. For example, the macroinitiator can be added to a coating formulation and during processing to form a co-polymer in situ. This co-polymer will then behave similarly to the preformed block co-polymers described in the above invention. In one specific example (see Example 19), the low surface energy macroinitiator can be added to polypropylene during melt processing forming a co-polymer in situ. At melt temperature, the nitroxide end group decouples from the macroinitiator allowing the free radical to abstract a hydrogen atom from the polypropylene backbone forming a matrix compatible low surface energy containing graft co-polymer, which can then bloom to the surface.

The advantageous properties of this invention can be observed by reference to the following examples, which illustrate but do not limit the invention.

### EXAMPLES

Glossary

| | |
|---|---|
| CYCAT ® 500 | Sulfonic acid catalyst (Cytec Industries, West |
| Catalyst | Patterson, NJ) |
| CYMEL ® 303 | Hexamethoxymethyl melamine (Cytec Industries, West |
| | Patterson, NJ) |
| iBA-DEPN | [N-t-butyl-N-(1-diethylphosphono-2,2,- |
| | dimethylpropyl)aminoxy]isobutyric acid |
| | mono-alkoxyamine |
| LUPEROX ® | t-Amyl peroxy(2-ethylhexanoate) polymerization |
| 575 | initiator (Arkema, Philadelphia, PA) |
| Nylon-6 | Capron 8200 NT nylon 6 (BASF, Florham Park, NJ) |
| PDMS | Poly(dimethylsiloxane) |
| PMMA | V825 Polymethyl methacrylate (Arkema, |
| | Philadelphia, PA) |
| PP | HB1602 Polypropylene, 12 Melt Flow Index (MFI) |
| | polypropylene (BP, Warrenville, IL) |
| ZONYL ® | Mixture of 1H,1H,2H,2H-perfluoroalkylacrylate esters, |
| TA-N | Average mol. wt. 569, bp_{(10 mmhg)} 100-220° C., mp |
| | 50-60° C. (E.I. du Pont de Nemours & Co., |
| | Wilmington, DE) |

### General Procedures

The block co-polymers were prepared using the following general procedures. Target molecular weights were achieved by setting the [M]/[I] ratio, followed by polymerization to the desired conversion necessary to reach the target molecular weight. Monomer conversion was conveniently monitored by gas chromatography analysis or flash devolitization of the monomer under vacuum. The polymer examples were run neat or in solution. Typical solvents used included toluene, ethyl benzene, ethyl 3-ethoxy propionate, and methyl ethyl ketone. Polymerizations were carried out at ambient pressures or run under nitrogen pressure. Polymerizations were run in standard polymerization vessels both with and without mixing, although adequate mixing was preferred. Surface tensions were determined using the sessile drop method (water, tetradecane) and dyne pens (fluid surface energies: 30 to 56 dynes/cm).

Block co-polymers were prepared by the addition of a monomer different from that used to form the first block. This second monomer composition then undergoes polymerization. After the second monomer polymerization is completed, the residual monomer can be removed or retained for further reaction. This procedure may be repeated to obtain multiblock co-polymers. Random and gradient block co-polymers were synthesized by polymerizing a mixture of two or more monomers.

### Example 1

This example illustrates preparation of a fluorinated polymer. Because the polymer has a nitroxide end group, it can function as a macroinitiator of free radical polymerization.

ZONYL® TA-N (160.587 g, 297 mmol) was added to a 100 ml jacketed glass reactor and heated with stirring under a nitrogen atmosphere to 55° C., where it became liquid. iBA-DEPN (11.348 g, 29.7 mmol) was added, and the reaction mixture heated at 110° C. for 3 hr. Gas chromatography showed the monomer conversion to be 90%. The reaction mixture, containing polymer and residual monomer, was a solid wax with a melting point of >90° C. Molecular weight by conversion and monomer to initiator ratio was estimated to be 4.7 kg/mol. The polydispersity was estimated to be 1.1-1.2.

### Example 2

This example illustrates preparation of an A-B diblock co-polymer starting from a fluorinated macroinitiator.

To 100 g of the macroinitiator formed in Example 1 was added 81.65 g of butyl acrylate. A strong exotherm was noted at 110° C. The reaction was stopped after 1 hr. The conversion of butyl acrylate, measured by gas chromatography, was 65%.

### Example 3

This example illustrates preparation of an A-B diblock co-polymer starting from a fluorinated macroinitiator followed by a residual monomer chase.

A mixture of 40.475 g ethyl 3-ethoxy propionate, 32.293 g of methyl methacrylate, and 27.593 g of butyl acrylate was bubbled with nitrogen for 10 min and added to 12.142 g of the macroinitiator formed in Example 1. The reaction mixture was heated 110° C. for 2 hr. Conversion was 82% of the methyl methacrylate and 53% of the butyl acrylate. To remove the residual monomers, LUPEROX® 575 and 30 g of ethyl 3-ethoxy propionate were added and the reaction mixture heated at 110° C. for 1 hr.

### Example 4

This example illustrates preparation of an A-B diblock co-polymer containing a functional monomer starting from a fluorinated macroinitiator.

A mixture of 43.428 g ethyl 3-ethoxy propionate, 31.746 g of methyl methacrylate, 26.315 g of butyl acrylate, and 5.781 g of 2-hydroxyethyl methacrylate was bubbled with nitrogen for 10 min and added to 13.00 g of the macroinitiator formed in Example 1. The reaction mixture was heated 110° C. for 2 hr. Conversion was 82% of the methyl methacrylate and 53% of the butyl acrylate. The conversion of 2-hydroxyethyl methacrylate was estimated to be about 82%. To remove the residual monomers, LUPEROX® 575 and ethyl 3-ethoxy propionate were added and the reaction mixture heated as in Example 3.

### Example 5

This example illustrates preparation of a fluorinated polymer and measurement of its surface tension as a solvent cast film on primed steel. Because the polymer has a nitroxide end group, it can function as a macroinitiator of free radical polymerization.

ZONYL® TA-N monomer (16.267 g) and 0.307 g of iBA-DEPN were added to a test tube and sealed with TEFLON® fluororesin cap and heated at 114° C. with stirring. The monomer melted after 6 min and heating was continued for a further 4 hr. Upon cooling, the reaction mixture formed a waxy solid. Mₙ=3 kg/mol. Polydispersity was 1.1. The polymer was solvent cast from tetrahydrofuran onto a primed steel sheet.

The surface tension of the steel sheet was 29.9 dyn/cm. The surface tension of the polymer on the steel sheet was 11.0 dyn/cm. The contact angles for water and for tetradecane on the primed steel sheet were 82.5° and 31.4°, respectively. The contact angles for water and for tetradecane on the polymer on the steel sheet were 109.5° and 78.8°, respectively.

### Example 6

This example illustrates preparation of an A-B diblock co-polymer starting from a fluorinated macroinitiator and measurement of its surface tension as a solvent cast film on both primed steel and aluminum sheet.

To 2.21 g of the macroinitiator formed in Example 5 was added 37.5 g of methyl methacrylate. The macroinitiator was insoluble in the methyl methacrylate. The mixture was poured into a 100 ml glass reactor, rinsed in with 20 ml of toluene, and heated at 103° C. for 2 hr. After 1.5 hr of heating, the cloudy mixture became clear. The resulting block co-polymer had Mₙ=138 kg/mol and a polydispersity of 2.0. The block co-polymer was solvent cast from tetrahydrofuran onto a primed steel sheet and onto an aluminum sheet. The surface tension of the polymer was 11.0 dyn/cm on the steel sheet and 9.4 dyn/crn on the aluminum sheet. The contact angles for water and for tetradecane on the polymer on the steel sheet were 115° and 75.4° and on the aluminum sheet were 114.5° and 83.7°, respectively. Although the block co-polymer has a block of methyl methacrylate, a non-low surface energy monomer, it has about the same surface energy as the polymer of Example 5, which does not contain a non-low surface energy monomer, indicating that self-organization has taken place at the surface.

### Example 7

This example illustrates preparation of a fluorinated polymer and measurement of its surface tension as a melt cast film on aluminum sheet. Because the polymer has a nitroxide end group, it can function as a macroinitiator of free radical polymerization.

ZONYL® TA-N monomer (8.6527 g) and 0.6237 g of iBA-DEPN were heated at 112° C. with stirring. The monomer melted after 6 min and stirring was continued at 110° C. for 15 hr. Conversion of the monomer, measured by gas chromatography, was 90%. Mₙ=2.7 kg/mol. Polydispersity was 1.15. The block co-polymer was melt cast onto an aluminum sheet. The surface tension of the polymer was 9.4 dyn/cm on the aluminum sheet. The contact angles for water and for tetradecane on the polymer on the aluminum sheet were 114.5° and 87.3°, respectively.

### Example 8

This example illustrates preparation of an A-B diblock co-polymer starting from a fluorinated macroinitiator and its surface tension as a melt cast film on aluminum sheet.

To 2.032 g of the macroinitiator formed in Example 7 was added 4.639 g of butyl acrylate. The reaction was heated at 118° C. for 3.75 hr. The hazy mixture became clear after about 0.25 hr. Conversion of the butyl acrylate, measured by gas chromatography, was 73%. Mₙ=14.6 kg/mol. Polydispersity was 1.24. The block co-polymer was melt cast onto an aluminum sheet. The surface tension of the polymer was 6.8 dyn/cm on the aluminum sheet. The contact angles for water and for tetradecane on the polymer on the aluminum sheet were 116° and 99.3°, respectively.

### Example 9

This example illustrates preparation of an A-B diblock co-polymer containing a low surface energy block.

Formation of a Fluorinated Macroinitiator A mixture of 0.0348 g (0.091 mmol) of iBA-DEPN and 2.0 g (8.4 mmol) of 1H,1H-perfluorobutyl acrylate was added to a 100 ml jacketed glass, purged with nitrogen, and heated to 118° C. without stirring. The reaction mixture thickened after several hours. The amount of 1H,1H-perfluorobutyl acrylate remaining was determined by gas chromatography of an aliquot taken from the reactor. Based on the conversion, the Mₙ of the polymer was estimated to be about 10 kg/mol.

Formation of an A-B Diblock Co-polymer starting from a Fluorinated Macroinitiator Butyl acrylate (21.3 g, 166 mmol) was added to the reaction mixture, which contained 1.7 g (0.17 mmol) of polymer, terminated by the nitroxide derived from iBA-DEPN initiator. The reaction mixture was heated to 118° C. under a nitrogen atmosphere with no stirring for 3 hr. The amount of butyl acrylate remaining was determined by gas chromatography. Based on the conversion, the number average molecular weight (Mₙ) of the butyl acrylate block was estimated to be about 65 kg/mol.

### Example 10

This example illustrates preparation of an A-B diblock co-polymer containing a block comprising a silicon-containing monomer.

A mixture of 399.8 g of butyl acrylate, 14.4 g of iBA-DEPN, and 0.38 g of DEPN in a 1 L jacketed stainless steel reactor was degassed with nitrogen and sealed under nitrogen. The reactor was heated at 116° C. for 3 hr. The butyl acrylate conversion was 70%. The reaction medium was cooled to 70° C., and the residual monomer removed under vacuum. A solution of 232 g of tri-iso-propyl silyl acrylate in 110 g of toluene was added to the reactor and the mixture heated at 119° C. for 2.5 hr. The conversion of the silicon-containing monomer was about 65%.

### Example 11

This example illustrates use of a low surface energy reactive A-B diblock co-polymer in a coating formulation.

The block co-polymer produced in Example 4 (18.690 g) was added to 75.860 g of dibasic esters. The resulting mixture was added to a high solids coating formulation at approximately 5% loading during the addition of reducing solvents. Acrylic high solids coating resins were formulated with CYMEL® 303 crosslinking agent, CYCAT® 4040 catalyst (0.4 wt % based on binder solids), and reducing solvents to achieve a 55% non-volatile matter (NVM) solution. The acrylic high-solids coatings (HSC) resin:crosslinker ratio was 75:25. Acrylic topcoats were then applied to light blue, metallic basecoated panels and cured at 140° C. for 30 min. The surface tension of the coating on the metallic panels was 15.8 dyn/cm. The surface tension of the HSC resin alone was >31 dyn/cm.

### Example 12

This example illustrates use of a low surface energy non-reactive A-B diblock co-polymer in a coating formulation.

The block co-polymer produced in Example 3 (20.121 g) was added to 80.414 g of dibasic esters. The resulting mixture was added to a high solids coating formulation at approximately 5% loading and cured as in Example 11. The surface tension of the coating was 14.6 dyn/cm.

### Example 13

This example illustrates preparation of an A-B diblock co-polymer containing a PDMS block via a PDMS macro initiator.

Attachment of iBA-DEPN to Hydroxyl Terminated PDMS Hydroxyl terminated PDMS (28 g, 0.006 mol) (Mₙ=4,670 g/mol) (Aldrich, Milwaukee, Wis.), 2.2 g (0.006 mol) of iBA-DEPN, and 0.73 g (0.006 mol) 4-dimethylaminopyridine are dissolved in an equal volume of toluene under anhydrous and inert atmospheric conditions in a reaction vessel equipped with mechanical stirrer, temperature probe, condenser, and addition funnel. The stirrer is started and the reaction vessel contents are cooled to 0° C. Dicyclohexylcarbodiimide (3.3 g, 0.016 mol) in toluene is added from the addition funnel. The reaction is stirred for 1 hr at 0° C., brought to room temperature, and stirred another 3 hr. The PDMS end capped with iBA-DEPN is precipitated by the addition of ethanol and subsequently isolated on a Buchner funnel.

Preparation of the Block Co-polymer A mixture of 30 g (0.006 mol) of the PDMS end capped with iBA-DEPN and 100 g (1 mol) of methyl methacrylate diluted to 50 wt % with toluene is heated to 70° C. for 1-2 hr. The excess methyl methacrylate and the solvent are removed under vacuum to yield the block co-polymer.

Other non-low surface energy monomer or mixtures of monomers, such as are listed above, may be used in place of or in addition to methyl methacrylate. For example, other acrylate and methacrylate monomers, styrene and substituted styrenes, acrylonitrile, and other free radical polymerizable monomers may be used in place of or in addition to methyl methacrylate to form block co-polymers.

### Example 14

This example illustrates preparation of an A-B diblock co-polymer containing a PDMS block via reactive chain end coupling.

Synthesis of a Carboxylic Acid Functionalized Poly(methyl methacrylate) Block A mixture of 100 g (1 mol) of methyl methacrylate, 0.762 g (0.002 mol) of iBA-DEPN and 46 g of toluene are added to a reaction vessel and the mixture is sparged with nitrogen for 10 min. The reaction vessel is heated to 70° C. with vigorous stirring. The temperature is maintained until desired conversion is reached (0.5-2 hr). The resultant carboxylic acid functionalized poly(methyl methacrylate) block is recovered by precipitation, or the residual monomers and solvent are removed under vacuum to yield a solid polymer block.

Preparation of the Block Co-polymer Hydroxyl functionalized PDMS and the carboxylic acid functionalized poly(methyl methacrylate) block are combined through reactive chain coupling. The chain coupling is carried out in the bulk using a tin catalyst. Alternatively, the chain coupling is carried out with dicylcohexylcarbodiimide by the method described in Example 13.

### Example 15

This example illustrates formation of a graft co-polymer containing a methyl methacrylate backbone and PDMS grafts.

A mixture of 100 g (1 mol) of methyl methacrylate, 10 g of 5,000 g/mol (0.002 mol) of vinyl terminated PDMS, 0.762 g (0.002 mol) of iBA-DEPN, and 46 g of toluene is added to a reaction vessel. The mixture is sparged with nitrogen for 10 min and then heated to 105° C. with vigorous stirring. The temperature is maintained until desired conversion is reached (about 2 hr). The resulting graft co-polymer is then isolated. The vinyl terminated PDMS co-polymerizes with the methyl methacrylate to produce a co-polymer in which PDMS blocks are grafted on a poly(methyl methacrylate) backbone.

### Example 16

This example illustrates preparation of a fluorinated oligomer with a nitroxide end group. Because the oligomer has a nitroxide end group, it can function as a macroinitiator of free radical polymerization.

A mixture of 3.8132 g (0.010 mol) iBA-DEPN and 11.0971 g (0.020 mol) of 1H,1H-perfluorodecyl acrylate and a stir bar was mixed in a 4 dram vial and heated to 80° C. in a drybath. After 30 min the temperature was increased to 110° C. for 20 min. Gas chromatography showed the monomer conversion to 95%. Molecular weight (Mn), calculated from the monomer conversion and the monomer to initiator ratio, was estimated to be 1.4 kg/mol.

### Example 17

This example illustrates preparation of an A-B diblock co-polymer starting from a fluorinated macroinitiator.

To 1.134 g of macroinitiator formed in Example 16 was added 30.384 g methyl methacrylate and 11.82 g toluene. The mixture was placed in a 100 mL jacketed glass reactor equipped with mechanical stirring and heated to reflux temperature (100-101° C.). The reaction was continued for 1.5 hr. Conversion of the methyl methacrylate, measured by gas chromatography, was 45%.

### Example 18

This example illustrates preparation of an A-B diblock co-polymer containing a functional monomer starting from a fluorinated macroinitiator.

Formation of a Fluorinated Macroinitiator A mixture of 1.1042 g (2.90 mmol) iBA-DEPN and 20.0473 g (0.036 mol) of 1H,1H-perfluorodecyl acrylate and a stir bar was mixed in a 4 dram vial, degassed with nitrogen, and heated to 110° C. in an aluminum heating block. After 4 hr the temperature was increased to 112° C. for 90 min. Conversion of the 1H,1H-perfluorodecyl acrylate monomer, measured by gas chromatography, was 72.8%. Based on this conversion, the Mₙ of the oligomer was estimated to be about 5.4 kg/mol. The resulting fluorinated oligomer has a nitroxide end group and can function as a macroinitiator of free radical polymerization.

Formation of an A-B Diblock Co-polymer starting from a Fluorinated Macroinitiator A mixture of methyl methacrylate (95.67 g, 0.954 mol) and methacrylic acid (4.33 g, 0.050 mol) was added to a 100 ml jacketed glass reactor containing the macroinitiator (5.424 g 0.001 mol) formed above, purged with nitrogen, and heated to 103° C. for 1 hr and 25 min. Conversion of the methyl methacrylate, measured by gas chromatography, was 62.7%. Molecular weight (Mₙ), calculated from the monomer conversion and the monomer to initiator ratio, was estimated to be 68.0 kg/mol.

### Example 19

This example illustrates the procedure for producing concentrates of low surface energy A-B diblock co-polymers IS-1 through S-7.

Block Co-polymer Sample Details Low-surface energy poly(ZONYL® TA-N-block-methyl methacrylate) co-polymers IS-1, IS-2, and IS-3 had Mₙ's=112 kg/mol, 84 kg/mol, and 50 kg/mol, respectively, and were ali prepared using a poly(ZONYL® TA-N) macroinitiator with Mₙ=4.7 kg/mol (estimated from ZONYL® TA-N conversion and the monomer to initiator ratio). Sample IS-4 was the poly(ZONYL® TA-N) macroinitiator (Mₙ=4.7 kg/mol), terminated with the nitroxide DEPN. Sample IS-5 was a block co-polymer comprised of poly(ZONYL® TA-N-block-butyl acrylate-block-methyl methacrylate) co-polymer with block Mₙ's=4.7 kg/mol, 5 kg/mol, and 50 kg/mol, for the poly(ZONYL® TA-N), poly(butyl acrylate), and poly(methyl methacrylate) blocks, respectively. Block co-polymer samples IS-6 and IS-7 comprised poly(1H,1H-perfluorodecyl acrylate-block-methyl methacrylate) and poly(1H,1H-perfluorooctyl acrylate-block-methyl methacrylate), respectively. The 1H,1H-perfluorodecyl- and 1H,1H-perfluorooctyl acrylate blocks had Mₙ's=1.4 kg/mol and 1.2 kg/mol, respectively. The poly(methyl methacrylate) blocks for each co-polymer had Mₙ's=20 kg/mol.

The samples of composite materials shown in Table 1 were prepared and tested using the following protocol. The block co-polymer samples were first compounded into a carrier resin, either polypropylene (PP) or polymethyl methacrylate (PMMA). The resin (PP/PMMA) and the block co-polymer were combined and dry mixed in a plastic bag and gravity fed into a 27 mm co-rotating twin-screw extruder fitted with a three-strand die (American Leistritz Extruder Corporation, Sommerville, N.J. USA). All samples were processed at 150 rpm screw speed using the following temperature profile: Zone 1-2=150° C., Zone 3-4=160° C., Zone 5-6=180° C., Zone 7-8=190° C. The resulting strands were subsequently cooled in a water bath and pelletized into approximately 6.35 mm pellets to provide a block co-polymer concentrate. Specific formulations produced are given in Table 1.

TABLE 1
Block Co-polymer Concentrate Formulations

| | Block Co- | | Resin:Block Co-polymer |
|---|---|---|---|
| Film | polymer | Resin | Ratio (wt. %) |
| C1 | IS-1 | PMMA | 90:10 |
| C2 | IS-2 | PMMA | 90:10 |
| C3 | IS-3 | PMMA | 90:10 |
| C4 | IS-4 | PMMA | 90:10 |
| C5 | IS-5 | PMMA | 90:10 |
| C6 | IS-6 | PMMA | 90:10 |
| C7 | IS-7 | PMMA | 90:10 |
| C8 | IS-1 | PP | 90:10 |
| C9 | IS-2 | PP | 90:10 |
| C10 | IS-3 | PP | 90:10 |
| C11 | IS-4 | PP | 90:10 |
| C12 | IS-2 | Nylon 6 | 90:10 |
| C13 | IS-4 | Nylon 6 | 90:10 |
| C14 | IS-5 | Nylon 6 | 90:10 |
| C15 | IS-6 | Nylon 6 | 90:10 |

### Example 20

This example illustrates the procedure for producing films containing low surface energy A-B diblock co-polymers IS-1 through IS-7.

Concentrates from Example 19 were added to resin at various letdown levels (as given in Table 2) and subsequently processed into films using the following procedure. The resin (PP/PMMA) and the block co-polymer concentrate were combined and dry mixed in a plastic bag and gravity fed into a 19 mm single screw extruder fitted with a blown film die, air ring and take off unit (C.W. Brabender Corporation, South Hackensack, N.J.). All samples were processed at 50 rpm screw speed using the following temperature profile: Zone 1=150° C., Zone 2=180° C., Zone 3=200° C., Die=220° C. The film die utilized had a 0.064 cm gap. The Nylon 6 samples were processed at 50 rpm screw speed using the following temperature profile: Zone 1=200° C., Zone 2=220° C., Zone 3=240° C., Die=240° C. Upon extrusion, the Nylon 6 films were quenched using a 3 chrome roll film take off unit (commercially available from C.W. Brabender Corporation, South Hackensack, N.J. USA). All of the resulting films were subsequently collected and samples were then analyzed for surface energy. Specific film formulations that were produced are given in Table 2.

TABLE 2
Film Formulations CE1 - CE3 and 1 through 45

| | | | Resin:Concentrate |
|---|---|---|---|
| Film | Concentrate | Resin | Ratio (wt %) |
| CE1 | — | PMMA | 100:0 |
| CE2 | — | PP | 100:0 |
| CE3 | — | Nylon 6 | 100:0 |
| 1 | C1 | PMMA | 90:10 |
| 2 | C1 | PMMA | 80:20 |
| 3 | C1 | PMMA | 50:50 |
| 4 | C2 | PMMA | 90:10 |
| 5 | C2 | PMMA | 80:20 |
| 6 | C2 | PMMA | 50:50 |
| 7 | C3 | PMMA | 90:10 |
| 8 | C3 | PMMA | 80:20 |
| 9 | C3 | PMMA | 50:50 |
| 10 | C4 | PMMA | 90:10 |
| 11 | C4 | PMMA | 80:20 |
| 12 | C4 | PMMA | 50:50 |
| 13 | C5 | PMMA | 90:10 |
| 14 | C5 | PMMA | 80:20 |
| 15 | C5 | PMMA | 50:50 |
| 16 | C6 | PMMA | 90:10 |
| 17 | C6 | PMMA | 80:20 |
| 18 | C6 | PMMA | 50:50 |
| 19 | C7 | PMMA | 90:10 |
| 20 | C7 | PMMA | 80:20 |
| 21 | C7 | PMMA | 50:50 |
| 22 | C8 | PP | 96:4 |
| 23 | C8 | PP | 92:8 |
| 24 | C8 | PP | 90:10 |
| 25 | C9 | PP | 96:4 |
| 26 | C9 | PP | 92:8 |
| 27 | C9 | PP | 90:10 |
| 28 | C10 | PP | 96:4 |
| 29 | C10 | PP | 92:8 |
| 30 | C10 | PP | 90:10 |
| 31 | C11 | PP | 90:10 |
| 32 | C11 | PP | 80:20 |
| 33 | C11 | PP | 50:50 |
| 34 | C12 | Nylon 6 | 95:5 |
| 35 | C12 | Nylon 6 | 90:10 |
| 36 | C12 | Nylon 6 | 75:25 |
| 37 | C13 | Nylon 6 | 95:5 |
| 38 | C13 | Nylon 6 | 90:10 |
| 39 | C13 | Nylon 6 | 75:25 |
| 40 | C14 | Nylon 6 | 95:5 |
| 41 | C14 | Nylon 6 | 90:10 |
| 42 | C14 | Nylon 6 | 75:25 |
| 43 | C15 | Nylon 6 | 95:5 |
| 44 | C15 | Nylon 6 | 90:10 |
| 45 | C15 | Nylon 6 | 75:25 |

### Example 21

This example illustrates the procedure for determining surface tension of film formulations CE1-CE3 and 1 through 45 from Table 2.

The surface tension of film samples made from formulations CE1, CE2, CE3, and 1 through 45 (Table 2) were tested using dyne pens (Enercon Industries, Menominee Falls, Wis. USA). Specifically, a line was drawn on each film using dyne pens having fluids representing the following surface tensions: 30, 32, 35, 38, 41, 44, 48, and 56 dynes/cm. A uniform line that does not bead indicates good surface wetting. Surface tension results are shown in Table 3.

TABLE 3
Film Formulations CE1 - CE3 and 1 through 45.

| Film | Surface Tension (Dyn/cm) |
|---|---|
| CE1 | 44 |
| CE2 | 30 |
| CE3 | 46 |
| 1 | 34 |
| 2 | <30 |
| 3 | <30 |
| 4 | 32 |
| 5 | <30 |
| 6 | <30 |
| 7 | 32 |
| 8 | <30 |
| 9 | <30 |
| 11 | <30 |
| 12 | <30 |
| 13 | <30 |
| 14 | <30 |
| 15 | <30 |
| 16 | <30 |
| 17 | <30 |
| 18 | <30 |
| 19 | <30 |
| 20 | <30 |
| 21 | <30 |
| 22 | <30 |
| 23 | <30 |
| 24 | <30 |
| 25 | <30 |
| 26 | <30 |
| 27 | <30 |
| 28 | <30 |
| 29 | <30 |
| 30 | <30 |
| 31 | <30 |
| 32 | <30 |
| 33 | <30 |
| 34 | <30 |
| 35 | <30 |
| 36 | <30 |
| 37 | <30 |
| 38 | <30 |
| 39 | <30 |
| 40 | <30 |
| 41 | <30 |
| 42 | <30 |
| 43 | <30 |
| 44 | <30 |
| 45 | <30 |

### Example 22

This example illustrates the procedure and results from surface chemistry determination via XPS (X-ray Photoelectron Spectroscopy) analysis on film formulations CE1 and 7 through 9 from Table 2.

Surface elemental analysis was done with a Kratos HS-AXIS spectrometer. Survey Spectra were obtained using the following conditions: the monochromatic aluminum anode was used at 210 W for the analysis (15 mA, 14 kV). The hybrid lens mode was selected, and the final aperture was 600×300 μm. Two sweeps (0-1340 eV) were acquired at 1 eV step, with a dwell of 1,000 ms, and pass energy of 160 eV.

Region spectra were acquired for O 1s, C 1s, and F 1s, using the following conditions: Twenty sweeps were collected at 0.1 eV step, 1,000 ms dwell, and 40 eV pass energy. All the region spectra were acquired at 210 W with the monochromatic aluminum anode (15 mA, 14 kV). A 70% Gaussian—30% Lorentzian functions were used to model the peaks for all decomposition work. A linear type background was used for the detailed spectra for modeling the background for quantification matters. No smoothing was done on the photoelectron signals. Spectra line reference was obtained from: Handbook of X-ray photoelectron spectroscopy (1992), Perkin-Elmer Corporation.

Results from the XPS analysis for wt % fluorine atoms at the film surface are shown in Table 4 for samples CE1 and 7 through 9 (from Table 2). Table 4 also shows the calculated fluorine concentration in the bulk films, which is dependent on the low surface energy block co-polymer loading level. In all cases for samples 7 through 9, the wt % fluorine at the surface was higher than the bulk fluorine concentration, indicating the low surface energy block co-polymers were “blooming” to the surface.

TABLE 4
Surface Fluorine results from XPS on
Film Formulations CE1 and 7 through 9

| Sample# | CE1 | 7 | 8 | 9 | |
|---|---|---|---|---|---|
| Block Co-polymer | — | IS-3 | IS-3 | IS-3 | |
| Loading (wt. %) | — | 1% | 2% | 5% | |
| Bulk F (wt. %) | — | 0.06% | 0.12% | 0.30% | |
| Surface F (wt. %) | — | 1.0% | 1.4% | 9.6% | 2.8%* |

*The opposite side of the film showed a different fluorine content.

### Example 23

This example illustrates preparation of a low surface energy end-functionalized polymer via a fluorinated ester of SG1C(CH₃)₂CO₂H. Because the polymer has a nitroxide end group, it can function as a macroinitiator of free radical polymerization.

Direct Esterification of iBA-DEPN with 1H,1H-Perfluorododecanol The alkoxyamine iBA-DEPN is esterified with 1H,1H-perfluorododecanol using dicyclohexylcarbodiimide by the method described in Example 13. Alternatively, iBA-DEPN can first be converted from the carboxylic acid to the acid chloride using thionyl chloride followed by reaction of this acid chloride product with 1H,1H-perfluorododecanol, as described in Example 2 of U.S. Pat. Pub. No. 2005/065119, incorporated herein by reference.

Indirect Esterification of iBA-DEPN with 1H,1H-Perfluorododecanol The iBA-DEPN alkoxyamine was rendered more thermally stable by capping the iBA initiator with 1 or 2 units of an acrylate, such as methyl acrylate. To a mixture of 22.57 g (0.262 mol) methyl acrylate diluted in 31 g ethanol was added 20.01 g (0.052 mol) iBA-DEPN in a 100 mL jacketed glass reactor equipped with mechanical stirring, purged with nitrogen, and heated to 70° C. for 2 hr. Conversion of methyl acrylate, measured by gas chromatography was 35.5%, corresponding to about 1.8 methyl acrylate units/iBA-DEPN molecule. The excess methyl acrylate and ethanol were removed under vacuum. The resulting product is used without further purification for esterification with 1H,1H-perfluorododecanol by either of the methods described in Example 13, above, or Example 2 of U.S. Pat. Pub. No. 2005/065119, incorporated herein by reference.

Preparation of the Polymer A mixture of methyl methacrylate diluted to 50 wt % in toluene is added to either of the reaction products formed above, (SG1-C(CH₃)₂CO₂CH₂(CF₂)₁₀CF₃ or SG1-(CH₂CHC(O)OCH₃)₂—(CH₃)₂CO₂CH₂(CF₂)₁₀CF₃) in a 100 mL jacketed glass reactor equipped with mechanical stirring, purged with nitrogen, and heated to 70° C. for 1-2 hr. The excess methyl methacrylate and solvent are removed under vacuum to yield a polymer with a fluorinated alkyl chain end group.

Having described the invention, we now claim the following and their equivalents.

1. A composite material having a surface tension of less than about 30 dyns/cm comprising:
a bulk component selected from the group consisting of a first bulk polymer and coating farming solutions; and
an additive component comprising a block copolymer comprising a first block prepared by polymerizing a first monomer in the presence of a nitroxide and a second block prepared by polymerizing a second monomer in the presence of a nitroxide wherein said first monomer and said second monomer each comprise an acrylic monomer, a methacrylic monomer, or a mixture thereof and wherein either said first monomer or said second monomer further comprise a monomer selected from the group consisting of fluorine containing monomers, silicon containing monomers and mixtures thereof; and
wherein the concentration of said additive component in said composite material is higher at a surface of said composite material than in the bulk of said composite material.

2. The composite material of claim 1 in which the amount of the additive component is about 0.3 wt % to about 5.0 wt % of the composite material.

3. The composite material of claim 1 in which the polydispersity of the block co-polymer is less than 2.5.

4. The composite material of claim 1 in which the nitroxide comprises a monovalent group in the β-position with respect to the nitrogen atom of the nitroxide, and in which the monovalent group has a molar mass greater than 15.

5. The composite material of claim 4 in which the monovalent group comprises a phosphoryl group.

6. The composite material of claim 1 in which the nitroxide is N-t-butyl-N-[1-diethylphosphono-(2,2,-dimethylpropyl)]nitroxide.

7. The composite material of claim 1 in which at least one of the first monomer and the second monomer comprises about 50 wt % to about 100 wt % of a monomer selected from the group consisting of fluorine containing monomers, silicon containing monomers and mixtures thereof.

8. The composite material of claim 1 in which at least one of the first monomer and the second monomer comprises about 25 wt % to about 100 wt % of a monomer selected from the group consisting of fluorine containing monomers, silicon containing monomers and mixtures thereof.

9. The composite material of claim 8 in which the monomer selected from the group consisting of fluorine containing monomers, silicon containing monomers and mixtures thereof is selected from the group consisting of fluorine-containing monomers and mixtures thereof, and the polydispersity of the block co-polymer is equal to or less than 2.5.

10. The composite material of claim 1 in which the monomer not selected from the group consisting of fluorine containing monomers, silicon containing monomers and mixtures thereof comprises a hydroxyl group, carboxylic acid group, glycidyl group or an amino group.

11. The composite material of claim 9 further comprising a second polymer free of monomers selected from the group consisting of fluorine containing monomers, silicon containing monomers and mixtures thereof to form a polymer mixture.

12. The composite material of claim 1 in which said first monomer and/or said second monomer are polymerized in a bulk polymerization system.
